(19) United States
(12) Patent Application Publication
(10) Pub. No.: US 2015/0056033 A1
(43) Pub. Date: Feb. 26, 2015

(54) UNIVERSAL OFFSET PORTABLE BORING BAR SUPPORT SYSTEM

(71) Applicant: Thomas ESSLINGER, Langdon, NH (US)

(72) Inventor: Thomas ESSLINGER, Langdon, NH (US)

(21) Appl. No.: 14/197,458

(22) Filed: Mar. 5, 2014

Related U.S. Application Data
(60) Provisional application No. 61/867,804, filed on Aug. 20, 2013.

(51) Int. Cl. B23B 29/02

(52) U.S. Cl. CPC B23B 29/027; B23B 29/022
USPC 408/110; 29/592

(57) ABSTRACT

A portable boring bar support system comprises first and second boring bar supports. Each boring bar support comprises a split clamping collar supported adjacent a first end of the boring bar support. The split clamping collar defines a clamping bore and facilitates releasable clamping attachment of a desired component thereto. A lug and fastener assembly of the split clamping collar controls a clamping motion of the split clamping collar. A mounting plate is supported adjacent a second opposite end of the boring bar support and a curvilinear section couples and integrally interconnects the split clamping collar with the mounting plate in an offset manner with respect to one another. The mounting plate has an opening therein which facilitates attachment of the boring bar support to a desired surface. The boring bar support system may be used with a spider support which has an integral split spider clamping collar.

### CROSS-REFERENCE TO RELATED APPLICATIONS

This application claims priority to U.S. provisional application Ser. No. 61/867,804 which was filed on Aug. 20, 2013.

### BACKGROUND OF THE INVENTION

1. Field of the Invention

The present invention relates to a universal offset support for supporting a boring bar of a portable boring device.

2. Description of Related Prior Art

Heavy equipment and machinery frequently requires repair and it is generally preferable that such repair be done in the field rather than transporting such machinery or the equipment to a suitable repair facility since field repair reduces the associated time and cost required for repair. One of the most commonly required repairs, for large machinery or equipment, is the repair of a bore, that is, a circular opening that supports an axle or a shaft, for example. These circular openings typically become damaged, or excessively worn, due to a variety of reasons and causes including mechanical wear of the parts. This results in a need to reshape or reconstruct the bore back to its original shape and diameter, e.g., possibly add a layer of material to the inwardly facing surface of the bore (e.g., “cladding”). It may also be desirable to modify a bore for any of a number of reasons, such as reconstructing the bore with a larger or a smaller diameter to accommodate a different size shaft or axle, for example.

The repair of a damaged or worn bore or the modification of a bore for any reason typically involves rebuilding the inwardly facing surface of the bore by the deposition of a metal, typically by a welding or a flame deposition process, and then the subsequent boring and/or machining the rebuilt or refabricated bore to the precisely required internal diameter. The material addition process is typically performed in the field by a rotatable portable welding or flame deposition device while the machining process is also typically performed in the field by a portable boring machine. Both of these processes utilize a boring bar that is inserted into and through the bore and precisely aligned with the bore to be rebuilt or refabricated. The boring bar typically supports one or more replaceable tools for machining the bore, such as a variety of conventual drilling or machining tools for machining and/or finishing the inwardly facing surface of the bore being rebuilt or refabricated. The boring bar is also typically supported by one or more spaced apart boring bar bearings which facilitate rotation of the boring bar.

As is conventional in the art, the boring bar is typically supported by at least a pair of bearings that are spaced apart from one another. Preferably the boring bar is supported so as to maximize the radial support and rigidity for the desired tool(s) that is necessary for accurate drilling, machining and/or finishing of the bore. Accurate drilling, repair or reconstruction of a bore requires the accurate guidance of the boring bar which may support a welding device, a drilling device, a machining and/or finishing tool(s), etc., with respect to the bore, in order to achieve the desired bore diameter as well as the desired machined finish on the inwardly facing surface of the bore.

The known portable welding or flame deposition devices and portable boring machines typically utilize boring bars that include a spine, which is a round steel shaft, typically called a boring bar. Boring bars are normally between 2 to 10 feet or more in length and are supported by securely anchored bearings that are aligned with respect to the bore that is to be machined, repaired and/or finished. Boring bars typically have one or more tool holes that extend completely through the center of the boring bar and are aligned perpendicular to a central axis of the boring bar. These tool holes are sized and shaped for receiving and supporting a variety of tools, e.g., cutting bits, for example. A mechanical drive, such as an electric or a hydraulic motor, rotates the boring bar, in a conventional manner, and either a manual or an automatic feed mechanism facilitates axial movement or conveyance of the boring bar during rotation. As a result of such rotation and axial movement of the boring bar, the supported tool(s) is forced into engagement with the inwardly facing surface to be refinished so as to facilitate the desired machine, repair and/or finishing of the inwardly facing surface of the bore(s) of the piece of equipment being repaired.

Each bearing(s), which typically supports the boring bar, is supported and anchored by a boring bar bearing supports. Each of the boring bar bearing supports, in turn, is anchored or secured to the piece of equipment being repaired. In some instances, the boring bar bearing supports are designed to support or attach other tooling equipment, such as bore welders, portable hones, etc.

Some known boring bar bearing supports permit the bearing support to vibrate during the machining processes. Such vibration is generally transferred on from the bearing support(s) to the boring bar and subsequently to the tool being utilized. Vibration in the boring bar is generally know to reduce the useful life of the supported cutting tool(s) as well as reduce the accuracy of the machined bore and thus must be avoided, or minimized as much as possible.

Additionally, the typical anchoring mechanisms for boring bar bearing supports comprise multiple anchoring elements which, in turn, leads to complicated and time intensive preparation and setup of the bearing supports, and thus the portable boring devices. Such bearing supports also typically require a relatively large installation space in order to be properly set up.

### SUMMARY OF THE INVENTION

Wherefore, it is an object of the present invention to overcome the above mentioned shortcomings and drawbacks associated with the prior art (e.g., overly complicated, time intensive, large installation space, minimal transferred vibration, and improved accuracy).

Another object of the present invention is to provide a universal offset portable boring bar support that features a rigid body which minimizes vibration which is transferred to the supported bearing bar, and thereby increases the useful life of any supported tools, e.g., cutting tool, etc., and also enhances the machining accuracy of the tool and improves the surface finish of the bore being repaired, machined, cut, finished, etc.

A further object of the present invention is to provide a universal offset portable boring bar support that is anchored by a single hold-down bolt or stud, thereby simplifying preparation and setup of the boring bar and the portable boring devices.

Yet another object of the present invention is to provide a pair of universal offset portable boring bar bearing supports that are each mounted with the clamp bores protruding or extending outward away from one another, in the standard support setup configuration, or each mounted with the clamp bores protruding or extending inward toward one another, in the inverted support setup configuration. In the standard support setup configuration, the boring bar support is positioned so as to provide maximum tool and bore access while, in the inverted support setup configuration, the boring bar support is positioned so as to maximize the rigidity of the boring bar accommodated by the boring bar supports. The selection of which set up to be utilize by the end user ultimately depends upon the requirements of the particular application. It is to be appreciated that when changing the support setup, from one support setup configuration to the other, any associated leveling screws have to be removed and threaded into the opposite side of the boring bar support.

A still further object of the present invention is to provide a universal offset portable boring bar bearing support in which the clamp bore bolt can be reversed so that access to the head is available from either side of the boring bar support. This is important when working in tight spaces and when one side of the portable boring bar bearing support is not readily accessible.

Yet another object of the present invention is to provide a universal offset portable boring bar bearing support in which a clamp bore bolt nut fits into one of two identically sized pockets, machined on each side of a clamp ear, so that access thereto is not required in order to prevent rotation of the associated nut when tightening/loosening the bolt, i.e., the associated pocket performs a gripping and retaining function.

Another object of the present invention is to provide a first universal offset portable boring bar support which can be bolted or secured, directly back to back, with a mating second universal offset portable boring bar support in a dual support setup configuration. This allows the universal offset portable boring bar supports to be utilized as a support for the boring bar when drilling or boring a blind hole(s), for example. The back to back dual support setup also enhances the rigidity provided by the boring bar supports to the boring bar.

A further object of the present invention is to provide universal offset portable threaded leveling screw holes which have reversible clamp bolts, with captive nuts, and which can be joined and aligned so as to allow insertion of a boring bar. Each of the boring bar support has a plurality of leveling screws or bolts which are utilized in order to level (e.g., adust the orientation) of the boring bar supports with respect to one another and the bore to be repaired, machined, cut, finished, etc. Each one of boring bar supports is capable of retaining either a spherical bearing, a plane bearing or a fixed alignment bearing. When two of the boring bar supports are joined face-to-face with one another, the leveling screws are typically removed and replace with leveling set screws which only engage with the threaded leveling screw holes of the universal offset portable boring bar support which is in abutting engagement with the supporting surface.

Another objective of the present invention is to provide a pair of universal offset portable boring bar supports which can be mounted in two different orientations to provide added utility.

The present invention also relates to a boring bar support comprising: a split clamping collar supported adjacent a first end of the boring bar support, the split clamping collar defining a clamping bore having a central axis, the clamping bore facilitating releasable clamping attachment of a desired component thereto, and a lug and fastener assembly of the split clamping collar controlling a clamping motion of the split clamping collar; a mounting plate supported adjacent a second opposite end of the boring bar support; a curvilinear section coupling and integrally interconnecting the split clamping collar with the mounting plate in an offset manner with respect to one another; and the mounting plate having an opening therein which facilitates attachment of the boring bar support to a desired surface.

The present invention also relates to a method of supporting a boring bar with a portable boring bar support system comprising first and second boring bar supports, and each of the first and the second boring bar supports comprising a split clamping collar supported adjacent a first end of the respective boring bar support, each split clamping collar defining a clamping bore having a central axis, each clamping bore facilitating releasable clamping attachment of a desired component thereto, and a lug and fastener assembly of the split clamping collar controlling a clamping motion of the split clamping collar; a mounting plate supported adjacent a second opposite end of the boring bar support; a curvilinear section coupling and integrally interconnecting the split clamping collar with the mounting plate in an offset manner with respect to one another; and the mounting plate having an opening which facilitates attachment of the boring bar support to a desired surface; the method comprising the steps of: supporting the first and the second boring bar supports on a piece of equipment to be repaired; and supporting the boring bar via the split clamping collar of at least one of the first and the second boring bar supports.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily drawn to scale since the emphasis is instead placed on illustrating the principles of the invention. The invention will now be described, by way of example, with reference to the accompanying drawings in which:

FIG. 1 is a top, front, side perspective view of a universal offset portable boring bar support according to the invention;

FIG. 2 is a side elevational view of the universal offset portable boring bar support of FIG. 1;

FIG. 3 is a bottom, front, side perspective view of the universal offset portable boring bar support of FIG. 1;

FIG. 4 is a top, rear, side perspective view of the universal offset portable boring bar support of FIG. 1;

FIG. 5 is a top, front, side perspective view of a universal offset portable boring bar support, according to FIG. 1, secured by a hold-down in a standard support setup configuration;

FIG. 6 is a bottom, rear, side perspective view of a universal offset portable boring bar support, according to FIG. 1, secured by a hold-down in an inverted support setup configuration;

FIG. 7A is a top, rear, side perspective view of a pair of universal offset portable boring bar supports, according to the invention, arranged in a dual support setup configuration and secured by a hold-down;

FIG. 7B is a bottom, rear, side perspective view of a pair of universal offset portable boring bar supports of FIG. 7A, according to the invention, arranged in a dual support setup configuration and secured by a hold-down;

FIG. 8 is a diagrammatic view showing a universal offset portable boring bar support system, according to the invention, mounted in a standard boring bar setup configuration to a piece of equipment to be repaired, machined, cut, finished, etc.;

FIG. 9 is a diagrammatic view showing a universal offset portable boring bar support system, according to the invention, mounted in an inverted boring bar setup configuration to a piece of equipment to be repaired, machined, cut, finished, etc.;

FIG. 10 is a diagrammatic view showing a universal offset portable boring bar support system, according to the invention, mounted in a dual bar setup configuration to a piece of equipment to be repaired, machined, cut, finished, etc.;

FIG. 11A is a diagrammatic perspective view of a universal offset portable boring bar support system, according to the invention, mounted to a piece of equipment to be repaired, machined, cut, finished, etc., in a bore welder center support arrangement;

FIG. 11B is a rear diagrammatic perspective view of a universal offset portable boring bar support system of FIG. 11A;

FIG. 12A is a diagrammatic perspective view of a spider support, for a universal offset portable boring bar support system according to the invention, supporting leveling screws in a first configuration;

FIG. 12B is a diagrammatic perspective view of the spider support according to FIG. 12A supporting leveling screws in a second configuration;

FIG. 12C is a diagrammatic perspective view of a spider support according to FIG. 12A supporting leveling screws in a third configuration;

FIG. 12D is a diagrammatic perspective view of a spider support according to FIG. 12A supporting leveling screws in a fourth configuration;

FIG. 13A is a diagrammatic front plan view of a spherical bearing for use with a universal offset portable boring bar support system according to the invention;

FIG. 13B is a diagrammatic sectional view along section line 13B-13B of FIG. 13A;

FIG. 14A is a diagrammatic front view of a cylindrical sleeve for use with bearing in a universal offset portable boring bar support system according to the invention;

FIG. 14B is a diagrammatic side elevational view of the cylindrical sleeve of FIG. 14A;

FIG. 15A is a diagrammatic front view of the combination of the spherical bearing of FIG. 13A and the cylindrical sleeve of FIG. 14A for insertion into the of one of the boring bar supports; and

FIG. 15B is a diagrammatic side elevational view of the cylindrical sleeve/bearing combination of FIG. 15A.

### DETAILED DESCRIPTION OF THE INVENTION

The present invention will be understood by reference to the following detailed description, which should be read in conjunction with the appended drawings. It is to be appreciated that the following detailed description of the various embodiments is by way of example only and is not meant to limit, in any way, the scope of the present invention.

The universal offset portable boring bar support system can be utilized for boring, machining and/or repairing a variety of different pieces of equipment. The types of equipment which generally use the boring bar support system are, for example, heavy-duty vehicles, heavy machines, trucks, construction equipment, engineering equipment, a variety of vehicles including bulldozers, graders, excavators, backhoes, loaders, etc., as well as heavy hydraulics components.

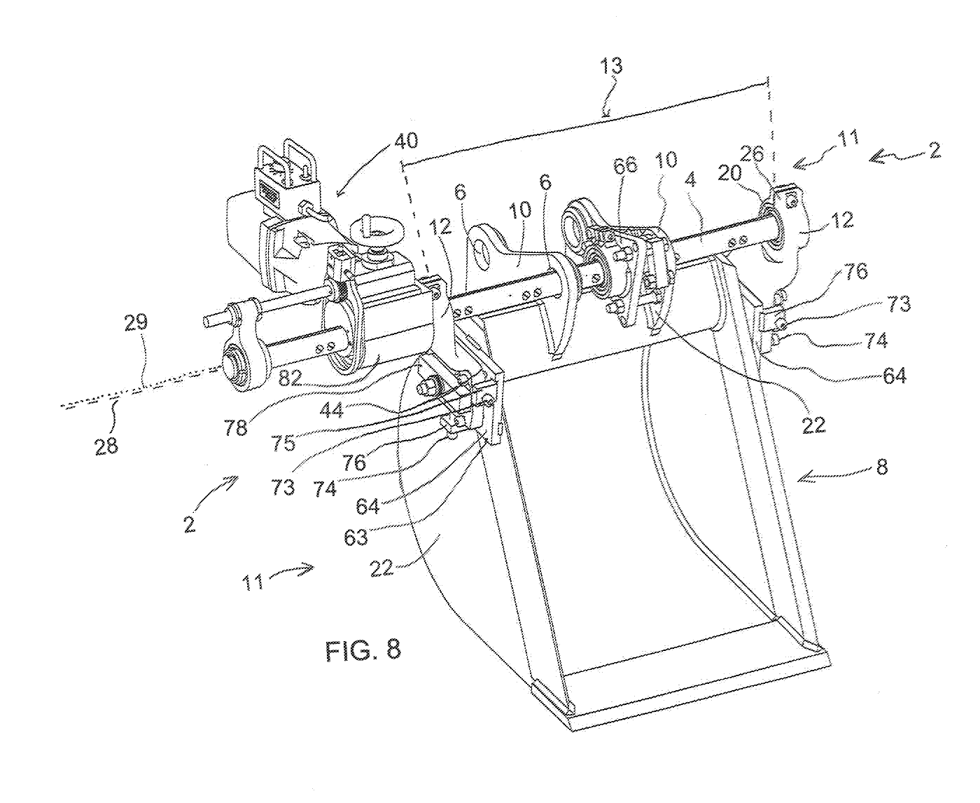

As generally shown in FIGS. 8-11B, the universal offset portable boring bar support system 2 is used to support a conventional boring bar 4 which is utilized, for example, for machining one or more surfaces of the piece of equipment 8 to be repaired, machined, cut, finished, etc. However, the boring bar 4, which is supported by the boring bar support system 2 described below in further detail, may also be utilized for refurbishing a bore 6, that is to say welding, drilling, repairing, finishing and refinishing one or more bores 6 formed in the piece of equipment 8 to be repaired. In the following example, the boring bar support system 2 is described as being utilized to repair a bore formed in a piece of equipment 8, e.g., a bucket of a backhoe in this instance.

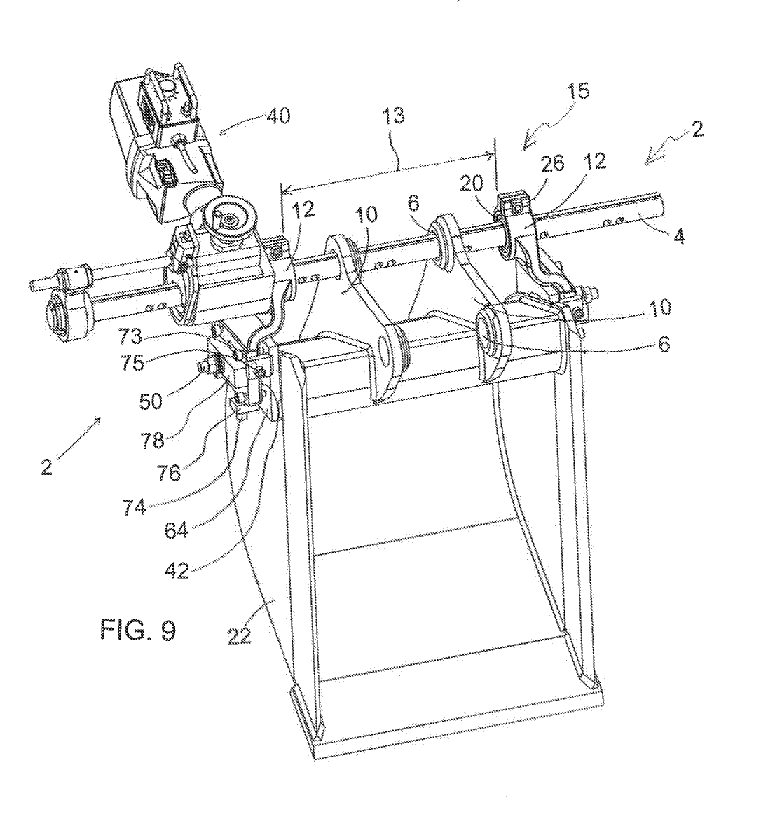

As is conventional in the art, the piece of equipment 8, e.g., the bucket of the backhoe, typically includes a pair of spaced apart brackets 10 that are permanently affixed to and formed integral with the bucket. Each bracket 10 typically includes at least one respective eye or through bore 6 which is designed to receive a shaft or pin and facilitate pivotal attachment, in a conventional manner, of the bucket to an arm of the backhoe, not shown in further detail. As generally shown in those FIGS. 8-11B, a drive motor 40 supplies rotatable drive to a conventional drive gearbox 82. One end of a conventional boring bar 4 engages with and is supported by the drive gearbox 82 while the opposite end of the boring bar 4 is supported by a bearing 20 secured to a first boring bar support 12 (see FIGS. 8 and 9). The drive gearbox 82 is directly secured to and supported by a second boring bar support 12. As is conventional in the art, the gearbox 82 supplies both rotational as well as axial movement of the boring bar 4, during use. If required or necessary, an intermediate section of the boring bar 4 may be supported by a spider 66 (FIGS. 8,11A and 11B) to provide additional support to the boring bar 4 and a further discussion concerning the same will follow below.

As generally shown in FIGS. 8-11B, typically a pair of universal offset portable boring bar supports 12 are utilized for each application. However, if desired or necessary, more than two boring bar supports 12 may be employed for any desired application.

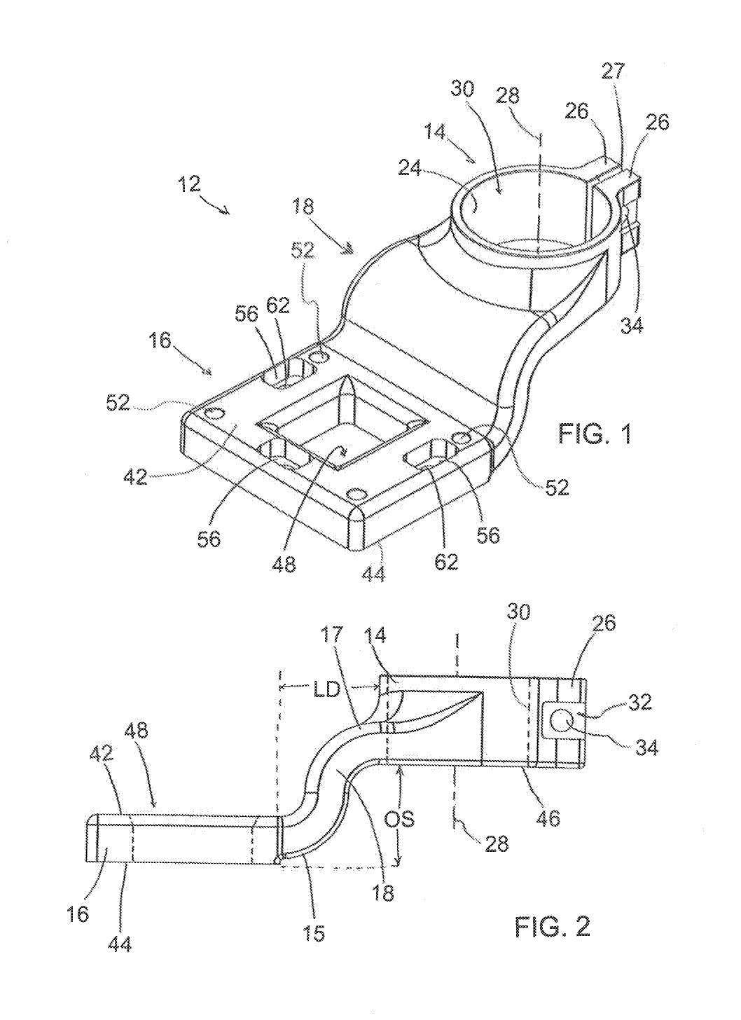

Now that at a brief discussion concerning use of the boring bar supports 12 has been provided, the detail discussion concerning the features of the boring bar support 12 will now be provided. Turning now to FIGS. 1-6, as generally shown therein, each boring bar support 12 generally comprises a split clamping collar 14 (a collar which has a removed section or gap which allows the diameter or size of the clamping collar to be slightly increased or decreased), at one end thereof, and a mounting plate 16, at an opposite end thereof. An intermediate curvilinear section 18 couples and integrally interconnects the split clamping collar 14 with the mounting plate 16, in an offset manner with respect to one another, as generally shown in FIG. 2. The integral connection of the mounting plate 16 and the clamping collar 14, via the curvilinear section 18, thereby forms a rigid universal offset portable boring bar support 12.

The clamping collar 14 is designed to clamp and retain a desired component, element, bearing 20, etc., which facilitates rotatable support of the boring bar 4, while the mounting plate 16 facilitates mounting of the universal offset portable boring bar support 12 to a desired support surface 22, e.g., a planar surface located on the piece of equipment 8 to be repaired, machined, cut, finished, etc. (see FIGS. 8-11B, for example) or, alternative, to a sub-plate 64 which is supported by the piece of equipment 8 to be repaired, machined, cut, finished, etc.

The clamping collar 14, of the boring bar support 12, comprises a cylindrically shaped inwardly facing clamping surface 24 for receiving and clamping the exterior surface of a desired component, element, bearing or possibly a cylindrical sleeve and a desired bearing (see FIGS. 15A and 15B). The following description describes the process of clamping a spherical bearing to the clamping collar 14, however, it is to be recognized that the clamping collar 14 may be utilized to clamp a variety of other types of bearings, such as plane or alignment bearings, for example, as well as other elements or components, such as the drive gearbox 82 or some other desired tool (see FIGS. 8-11B).

As is well known and generally shown in FIGS. 13A and 13B, a conventional spherical bearing 20 typically includes an outer ring or race 21 that supports an inner ring or race 19. Typically, the mating spherical surfaces of the inner and the outer races 19, 21 are both precisely machined to closely mate with one another facilitate pivoting movement. Preferably, the outer race 21 has a small cut or gap 23 formed therein, e.g., it is a split outer race, so as to enable the diameter of the outer race 21 to be slightly reduced and compressed, e.g., by about 0.0005-0.100 around the circumference of the inner race 19 when the split spherical bearing 20 is received and clamped by the clamping collar 14 of the boring bar support 12. As such split spherical bearings are well known in the art, a further detailed description concerning the same is not provided.

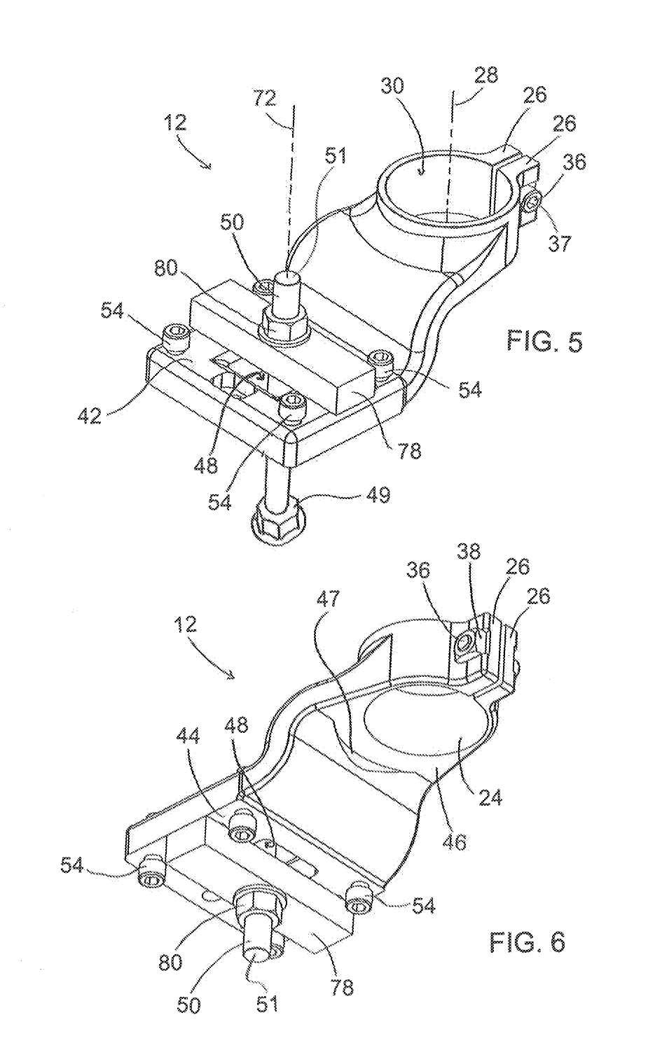

As shown in FIGS. 1-6, the opposed ends of each section of the collar 14 terminate in a respective lug 26 which facilitate clamping of a desired item, e.g., element, component, drive gearbox 82 or bearing 20, by the clamping collar 14. The lugs 26 are spaced apart from one another by a small distance or gap 27, e.g., ⅛ to ¼ of an inch or so. Each one of the lugs 26 has a bolt hole 34 which extends completely through the respective lug 26. The bolt holes 34 are aligned with one another so as to facilitate receiving a clamping bolt 36 (FIGS. 5 and 6). In addition, each of the lugs 26 has a recessed pocket 32 formed therein for closely accommodating and preventing rotation of a desired nut 38 (FIG. 6) while still facilitating rotation of a cylindrical head 37 of a respective clamping bolt 36 by an alien wrench, for example.

As the clamping bolt 36 is sufficiently tightened with respect to the mating nut 38, such tightening of the clamping bolt 36 gradually biases the two lugs 26 toward one another thereby reducing the size of the gap 27 and correspondingly reducing the overall diameter 25 of the cylindrical clamping surface 24. Such gradual reduction of the diameter 25 of the cylindrical clamping surface 24, in turn, applies a clamping force on the outer race 21 of the bearing 20, for example. The clamping force induced on the outer race 21 is at least partially transferred to the inner race 19 which, in turn, slightly constricts so as to reduce the diameter of the inner race 19, e.g., between 0.0005 to about 0.0015 of an inch or so, for example. Such constriction of the diameter of the inner race 19 thereby takes ups or minimizes any associated “play” between the inwardly facing surface of the inner race 19 and the accommodated or supported boring bar 4 while lubrication, located between the inner race 19 and the supported boring bar 4 assists with permitting axial sliding movement of the boring bar 4 relative to the inner race 19.

When the clamping bolt 36 and the mating nut 38 are loosened relative to one another, such loosening correspondingly permits the lugs 26 to move gradually away from one another and return back toward their normal relaxed positions. This, in turn, thereby increase the size of the gap 27 as well as increase the diameter 25 of the cylindrical clamping surface 24 so as to facilitate release of the bearing 20, or some other element or component, from the cylindrical clamping surface 24.

It is to be appreciated that both of the recessed pockets 32 are sized to receive either the head of the clamping bolt 36 or closely receive the corresponding mating nut 38. Preferably the size of the recessed pockets 32 closely corresponds to the size of the mating nuts 38 such that when a mating nut 38 is received within the recessed pocket 32, the mating nut 38 is prevented from rotating while the cylindrical head 37 is permitted to rotate. During use, a mating nut 38 is received within the recessed pocket 32 of one of the lugs 26 and aligned with the bolt hole 34. Thereafter, the mating clamping bolt 36 is inserted into the bolt hole 34 of the other lug 26, threaded end first. Once the threaded end of the bolt 36 is properly aligned with the mating nut 38, an appropriately tool, e.g., an alien wrench, is used to rotate the clamping bolt 36 with respect to the mating nut 38 and suitably decrease the diameter of the clamping collar 14. Since the recessed pocket 32 prevents the mating nut 38 from rotating, the clamping bolt 36 and the mating nut 38 can be tightened or loosened using only a single tool, thereby simplifying the clamping/releasing process. Moreover, as the recessed pockets 32 are identical in shape and size to one another, the arrangement of the clamping bolt 36 and the mating nut 38 can be readily reversed and still be suitably loosened or tightened by using only a single tool. That is, the assembly of the clamping bolt 36 and the mating nut 38 can be rearranged so as to facilitate tightening and loosening of the clamping collar 14, from either side, and this is particularly useful when access to the clamping collar 14, from one side for example, is limited or restricted for some reason.

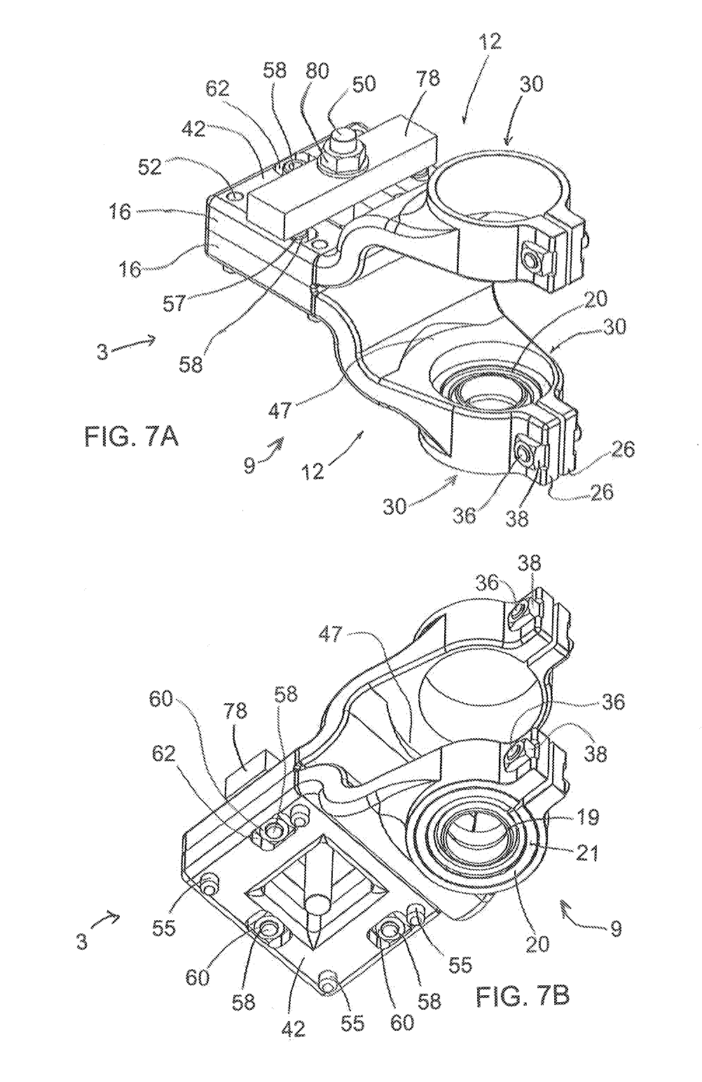

As shown in FIGS. 1, 2 and 5, the cylindrical clamping surface 24 defines a centrally located clamping bore 30 which defines a central axis 28. The clamping collar 14 is made from a somewhat resilient material, e.g., a metal such as ductile iron, which can either be the same material or a different material from the material from which the mounting plate 16 and/or the curvilinear section 18 are manufactured. Preferably, at least the clamping collar 14 is sufficiently flexible so that, in its relaxed state (see FIGS. 1-4, for example), the lugs 26 are sufficiently spaced from one another to thereby allow easy insertion or removal of a desired item, element, component or bearing 20 therefrom. While the lugs 26, when in their clamped position (see FIGS. 7A-7B, for example), the lugs 26 are located closely adjacent one another, e.g., and may possibly abut with one another, to facilitate desired clamping of the desired item, element, component or bearing 20 by the respective clamping collar 14.

During the process of tightening the clamping collar 14, via the clamping bolt 36 and mating nut 38, first the clamping collar 14 engages with the outer race 21 of the bearing 20 thereby preventing rotation or movement of the outer race 21 with respect to the clamping collar 14. Continued tightening of the clamping collar 14 gradually constricts and compresses the outer race 21 radially inward which thereby further gradually clamps the inner race 19 and reduces any undesired “play” between the inner and outer races 19, 21. Further tightening of the clamping collar 14 gradually constricts and compresses the outer race 21 which, in turn, gradually constricts and compresses the inner race 19 toward the boring bar 4 so as to reduce any undesired/ unwanted “play” between the inner race 19 and the boring bar 4. In this manner, undesired movement of the inner race 19 with respect to the outer race 21 is prevented and undesired radial movement of the boring bar 4 with respect to the inner race 19 is substantially eliminated while, at the same time, the lubricant still permits the boring bar 4 to slide axially relative to the inner race 19. As noted above, the clamping collar 14 can also be utilized to clamp and hold a conventional drive gearbox 82 or a plug-in center support 86 of a bore welder 84, for example, instead a desired bearing 20 in which neither any radial nor any axial movement is desired between the clamping collar 14 and the clamped drive gearbox 82, plug-in center support 86, etc.

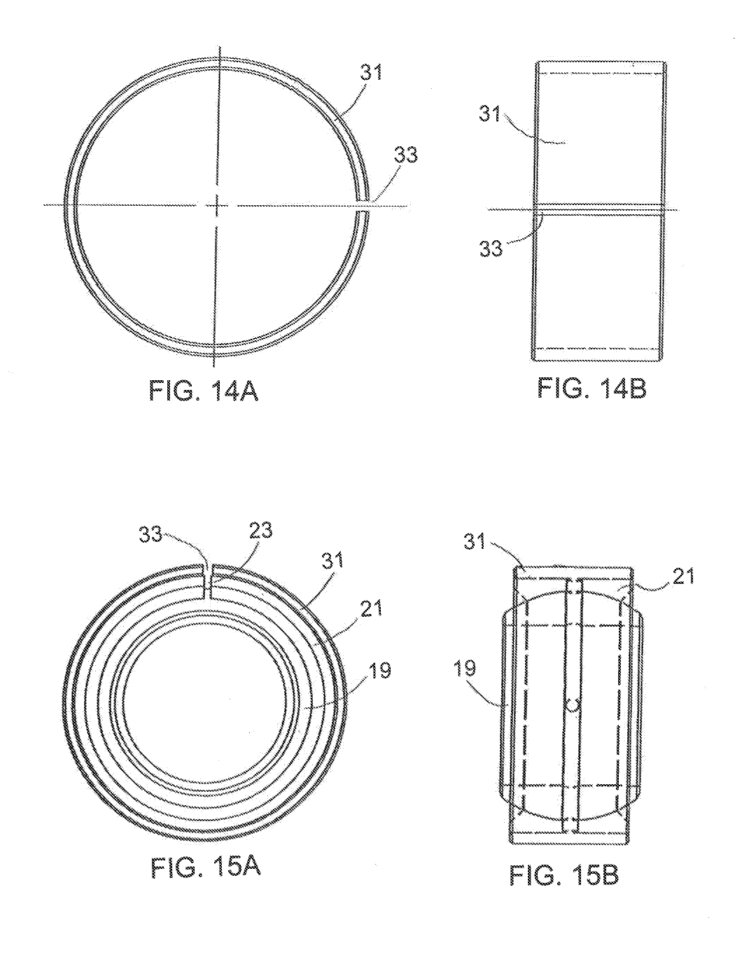

It should be recognized that a number of different types and sizes of bearings may be utilized by the universal offset portable boring bar support system 2. Occasionally it may be desirable to utilize a bearing 20, having a smaller diameter, with the support system 2 for supporting a smaller diameter boring bar 4. In such instance, a smaller spherical bearing (see FIGS. 13A and 13B) is used in combination with a cylindrical sleeve 31 (see FIGS. 14A and 14B) that has an inner sleeve diameter which is suitably sized to closely accommodate and engage with the exterior surface of the outer race 21 of the bearing 20 and an outer diameter of the cylindrical sleeve 31 is suitably sized so as to be received within and clamped by the clamping bore 30 of the clamping collar 14. Preferably the cylindrical sleeve 31 and the outer race 21 of the bearing 20 each have a cut or gap 23, 33, e.g., both the sleeve and the outer race are each split. Although not absolutely necessary, in order to reduce the force required to clamp the smaller bearing 20 and sleeve 31 via the clamping collar 14, preferably the gap 23 of the outer race 21 of the bearing 20 and the gap 33 of the cylindrical sleeve 31 are substantially aligned with one another, as generally shown in FIG. 15A. Preferably both of those two gaps 23 and gap 33 are also substantially aligned with the gap 27 of the clamping collar 14. By use of a cylindrical sleeve 31 with an outside diameter of about 3.48 inches and an appropriately sized inner diameter, the clamping collar 14, with an inside diameter 25 of 3.48 inches, for example, can be utilized to clamp a 1¾ inch bearing, a 2 inch bearing, a 2¼ inch bearing, etc.

Although the mounting plate 16 is generally shown as being rectangular in shape, it is to be appreciated that the mounting plate 16 can have a variety of other shapes and forms, e.g., be circular, triangular, polygonal, or possibly have virtually any other desired shape. As best shown in FIGS. 1-4, the mounting plate 16 has a first surface 42 and a second surface 44 that are located on opposite sides of the mounting plate 16. The mounting plate 16 is formed from a metal which is preferably a steel, ductile iron or some other metal with similar qualities. The mounting plate 16 typically has a length of between 3 and 8 inches, and more preferably a length of about 4½ inches, and the mounting plate 16 has a width of between 3 and 8 inches, and more preferably has a width of about 6 inches. The mounting plate 16 typically has a thickness of between ½ and 2 inches, and more preferably a thickness of about 1 inch.

As shown in FIG. 2, the curvilinear section 18 includes a two sharp bends so that a side profile, of the universal offset portable boring bar support 12, generally has the shape of the letter S. The curvilinear section 18 comprises a first bend 15 of approximately 90 degrees (FIG. 2) and a second bend 17 of approximately 90 degrees. Although the exact profile of the curvilinear section 18 is not critical, the important aspect of the curvilinear section 18 is that it provide a sufficient offset spacing OS of the clamping collar 14 with respect to the mounting plate 16, as generally shown in FIG. 2. Preferably, the offset spacing OS ranges from 1 to 5 inches, for example. To maintain the relationship between the mounting plate 16 and the clamping collar 14, the curvilinear section 18 is formed from a material that is generally quite rigid, e.g., steel, ductile iron or some other metal, and has a thickness of between ½ and 2 inches, and more preferably a thickness of about 1 inch.

Due to the curvature of the curvilinear section 18, the second surface 44 of the mounting plate 16 extends parallel to but is spaced from the corresponding second surface 46 of the clamping collar 14 by the desired offset spacing OS (see FIG. 2). The second surface 44 of the mounting plate 16 is machined perfectly flat so as that the second surface 44 lies in a plane which extends precisely perpendicular to the central axis 28 of the clamping bore 30. The curvilinear section 18 also laterally spaces the mounting plate 16 from the clamping collar 14 by a lateral displacement LD (FIG. 2). It is important to recognized that the rigidity of the boring bar support 12 will be affected by amount of offset spacing OS as well as the lateral displacement LD of the mounting plate 16 with respect to the clamping collar 14. As such, the curvilinear section 18 should be shaped, sized and dimensioned so as to maintain the desired rigidity of the boring bar support 12 and orientation of the mounting plate 16 and the clamping collar 14 with respect to one another during use.

As shown in FIGS. 1, 3 and 4, for example, the mounting plate 16 has a centrally located rectangular bolt opening 48 formed therein. The bolt opening 48 typically has length of between 1 and 6 inches, and more preferably a length of between 2 and 3 inches and typically has a width of between 1 and 6 inches, and more preferably a width of between 2 and 3 inches. Most preferably, the bolt opening 48 has length of 2½ inches and a width of 2¼ inches.

As shown in FIGS. 1, 3 and 4, at least three, e.g., typically four, leveling screw holes 52 are formed in the mounting plate 16, e.g., adjacent each corner thereof. Each one of the leveling screw holes 52 is threaded and extends completely through the mounting plate 16 from the first surface 42 to the second surface 44. Each one of the leveling screw holes 52 accommodates a threaded leveling screw 54 (or possibly a leveling set screw as described below in further detail) which facilitates desired adjustment of the boring bar support 12, as will be described below in further detail. The leveling screw holes 52 are sufficiently spaced from one other about the perimeter of the mounting plate 16. While the leveling screw holes 52 are shown as being located adjacent each corner of the mounting plate 16, it is to be appreciated that the number and location of the mounting screw holes 52 can vary from application to application, without departing from the spirit and scope of the present invention.

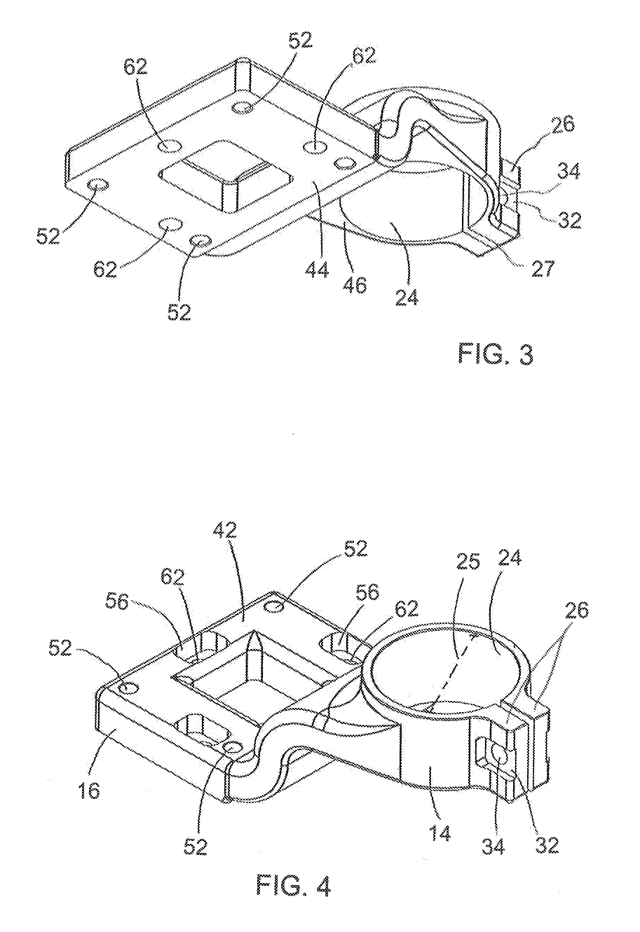

As shown in FIGS. 1 and 4, three recessed pockets 56 are formed in the first surface 42 of the mounting plate 16 and each one of these pockets 56 can be cast, machined or milled into the mounting plate 16. As shown in FIG. 3, each one of the pockets 56 has a base surface and an associated joining bolt hole 62 which is generally centered with respect to base surface of the pocket 56 and extends completely through the mounting plate 16 to the second surface 44.

As generally shown in FIGS. 7A, 7B, each joining bolt hole 62 is sized to accommodate a joining bolt 58 which facilitates direct coupling of the mounting plates 16, of two boring bar supports 12, face-to-face with one another when a dual support setup configuration is desired. That is, the second surface 44, of a first mounting plate 16, is directly secured against the second surface 44 of a second mounting plate 16. It is important to note that since each of the second surfaces 44 of the mounting plates 16 extends perpendicular to the central axis 28 of the corresponding clamping bore 30, when the second surfaces 44 of the mounting plates 16 are secured together with one another, as shown in FIGS. 7A and 7B, the central axes 28 of the clamping bores 30 are co-linear with one another. Each pocket 56 is sized so as to receive and sufficiently recess either an associated nut 60 or a head 57 of a joining bolt 58 within the respective pocket 56. The purpose and function of joining two boring bar supports 12 with one another, in an dual support setup configuration, will be described below in further detail.

As shown in FIGS. 5 and 6, a threaded hold-down bolt 50 can be accommodated within the bolt opening 48 of the mounting plate 16 so as to allow limited relative movement of the boring bar support 12 with respect to the hold-down bolt 50. The bolt opening 48 is sized to receive the hold-down bolt 50 but still allow limited to and fro movement, of the mounting plate 16 with respect to the hold-down bolt 50, in a first direction, and also allow limited to and fro movement, of the mounting plate 16 with respect to the hold-down bolt 50, in a second direction, perpendicular to the first direction, and thereby facilitate adjustment of the location of the boring bar support 12 relative to the surface 22, 63, As discussed below, a head or a trailing end of the hold-down bolt 50 is typically tack welded or otherwise temporarily secured directly to a desired surface 22 in order to facilitate temporary, but secure, attachment of the boring bar support 12 to such surface. Alternatively, the head or the trailing end of the hold-down bolt 50 may be permanently attached to a central portion of a surface of a sub-plate 64 (see FIGS. 8-10, for example), with the hold-down bolt 50 extending normal to that surface so as to facilitate attaching a boring bar support 12 thereto.

As generally shown in FIGS. 5-10, a hold-down 78, e.g., a rectangular bar stock, has a length which is longer than the width of the opening 48 so that the opposed ends of the hold-down 78 overlap and engage with at least a portion of the first or the second surface 42, 44 of the mounting plate 16, depending upon the configuration. A leading threaded end 51 of the hold-down bolt 50 has a length such that the leading threaded end 51 passes through both the opening 48 and a central aperture of the hold-down 78 and still has an exposed portion which facilitates engagement with an associated nut 80. As the nut 80 is tightened with respect to the hold-down bolt 50, such tightening draws the hold-down 78 toward the trailing end/head 49 of the hold-down bolt 50 (FIG. 1) and facilitates clamping of the boring bar support 12 to the surface 22/sub-plate 64 while loosening of the nut 80, in the opposite rotational direction, facilitates adjustment or removal of the boring bar support 12 relative to the surface 22/sub-plate 64,

As generally shown in FIGS. 8-10, the sub-plate 64 has a vertical tab 76 located along a bottom edge surface thereof and a horizontal tab 75 located along one of the side edge surfaces of the sub-plate 64. Each tab 76 or 75 extends generally normal to a support surface 63 of the sub-plate 64 and has a threaded bore (not numbered) therein which accommodates a respective adjustment screw 74, 73. The vertical adjustment screw 74 engages with the vertical tab 76 and facilitates manual vertical adjustment of the boring bar support 12 relative to the sub-plate 64, once the nut 80 and the hold-down 78 are sufficiently loosened. The horizontal adjustment screw 73 engages with the horizontal tab 75 and facilitates manual horizontal adjustment of the boring bar support 12 relative to the sub-plate 64, also once the nut 80 and the hold-down 78 are sufficiently loosened.

It should be noted that, when machining a surface such as a bore 6, precise alignment of the boring bar 4 with respect to the surface to be repaired, machined, cut, finished, etc., can be critical. As such, it is extremely beneficial to adjust vertical and/or lateral positions of the clamping bore 30 of the boring bar support 12 as well as the angular orientation of the central axis 28 of the clamping bore 30 with respect to a central axis 29 (FIG. 8) of the bore 6 to be repaired, machined, cut, finished, etc. The vertical and lateral alignment of the central axis 28 of the clamping bore 30 with the central axis 29 of the bore 6 to be repaired, machined, cut, finished, etc., can be easily achieved by loosening the nut(s) 80 and the hold-down(s) 78 and adjusting the position of the boring bar support(s) 12, relative to the hold-down bolt 50, via adjustment of the vertical and/or horizontal adjustment screws 74, 75, as discussed above. It is to be appreciated that the range of up and down vertical and left and right lateral movement of the boring bar support 12 depends on the overall size and dimensions of the bolt opening(s) 48, relative to the hold-down bolt(s) 50, and the length of the vertical and/or horizontal adjustment screws 74, 75.

Adjustment of the angular orientation of the support clamping bore central axis 28, with respect to the bore central axis 29 of the bore 6 to be repaired, machined, cut, finished, etc., is accomplished by adjustment of the mounting plate 16 relative to the support surface 22, 63. That is, the machined second surface 44 of the mounting plate 16 is adjusted or altered so that the second surface 44 does not lie completely flush against the support surface 63 of the sub-plate 64 or the surface 22. Commencing from a starting position in which the machined second surface 44 of the mounting plate 16 lies flush against the outwardly facing support surface 63 of the sub-plate 64 or the surface 22, the nut 80 is sufficiently loosened, relative to the hold-down bolt 50, so that the hold-down 78 permits sufficient relative movement of the boring bar support 12 axially with respect to the hold-down bolt 50, e.g., limited axial movement of the mounting plate 16 toward and away from the outwardly facing surface 63 of the sub-plate 64 or the surface 22.

Next, a desired one or more of the leveling screws 54 is threaded into or out of a desired one or more of the leveling screw holes 52, located about the perimeter of the mounting plate 16. Once the leading end of leveling screw 54 abuts and engages with the surface 63 of the sub-plate 64 or the surface 22, continued rotation of the leveling screw 54 gradually biases a portion of the mounting plate 16 away from the sub-plate 64 or the surface 22 and, in turn, alters the orientation of the central axis 28 of the clamping bore 30. By suitable adjustment of one or more of the leveling screws 54, an operator can readily adjust and alter the angular orientation of the central axis 28 of the clamping bore 30 with respect to the central axis 29 of the bore 6 to be repaired, machined, cut, finished, etc., so that both axes 28, 29 lie substantially coincident with one another. It is to be appreciated that use of a spherical bearing 20, for example, also assists with compensating for any slight or minor misalignment which occurs between the central axis 28 of the clamping bore 30 and the central axis 29 of the bore 6.

To assist with determining the general location for mounting the boring bar supports 12 to a piece of equipment 8 to be repaired, machined, cut, finished, etc., typically a boring bar 4 is supported within the bore 6 to be repaired, machined, cut, finished, etc., by a pair of conventional cones (not shown). As is conventional in the art, the pair of cones facilitate properly and precisely centering the boring bar 4 with respect to the bore 6. Once the boring bar 4 is supported by a pair of cones, then an operator can readily determine the general location for supporting the boring bar 4 during the intended repair. Thereafter, the hold-down 50 or the sub-plate 64 is tack welded to the surface 22 at a location such that when the bolt opening 48 of the mounting plate 16 engages with the hold-down 50, the clamping collar 14 of the boring bar support 12 will be generally located concentric with respect to the boring bar 4.

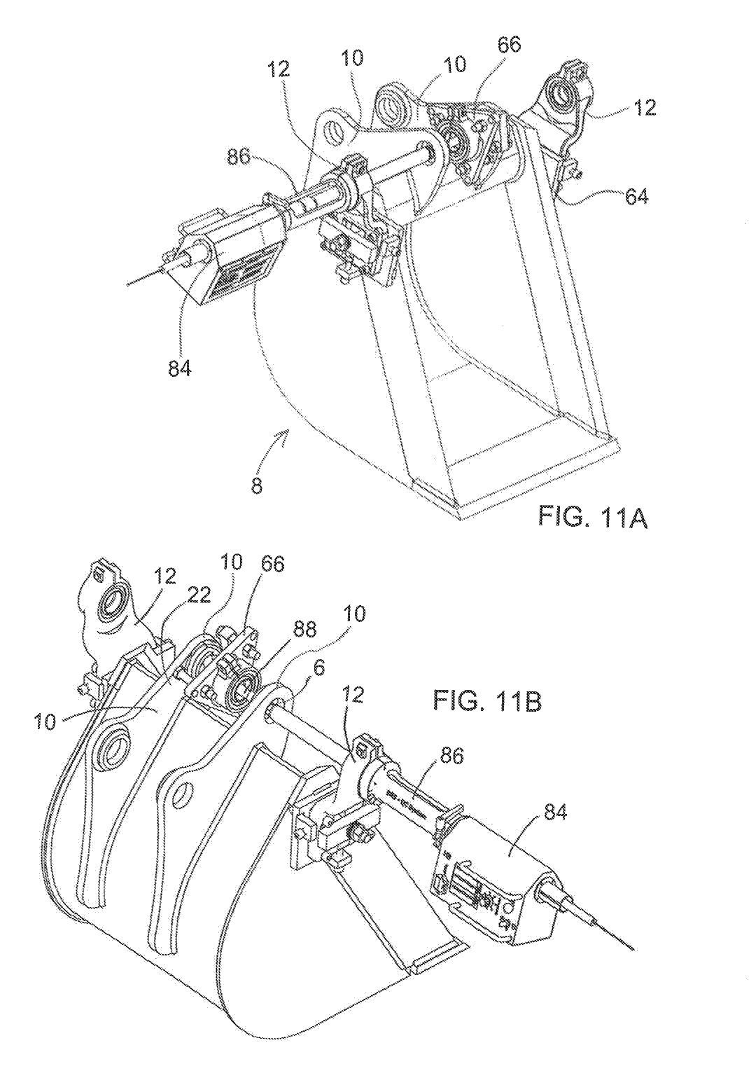

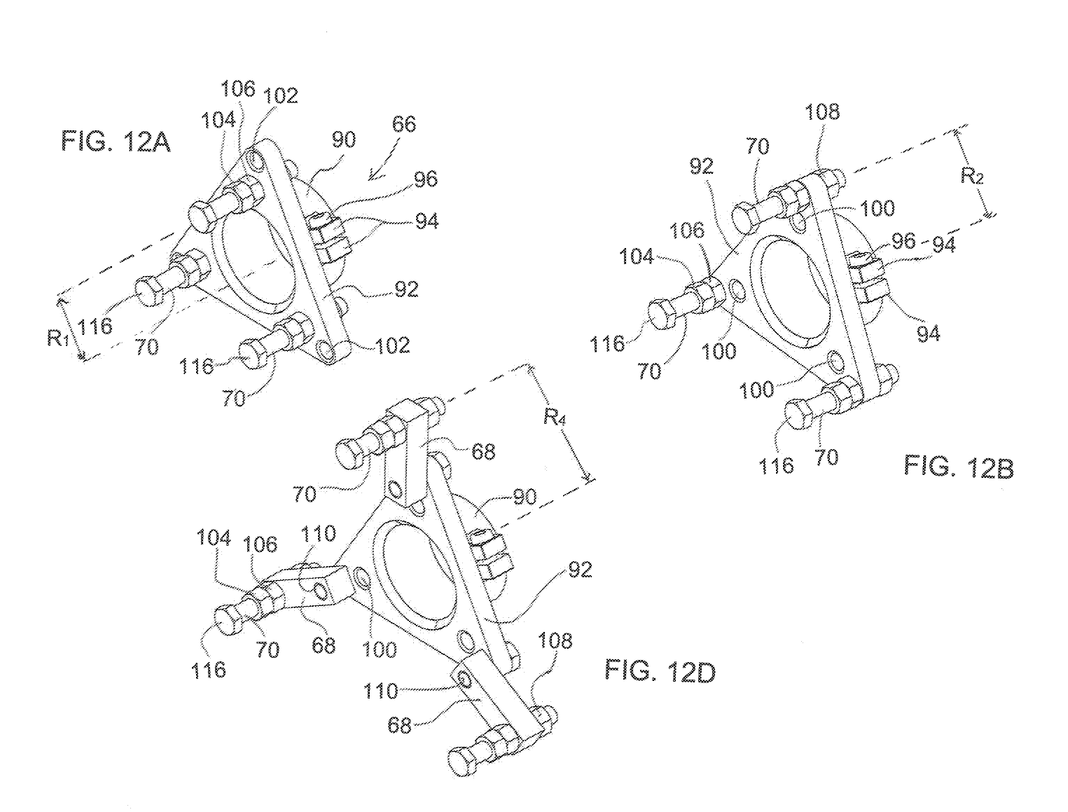

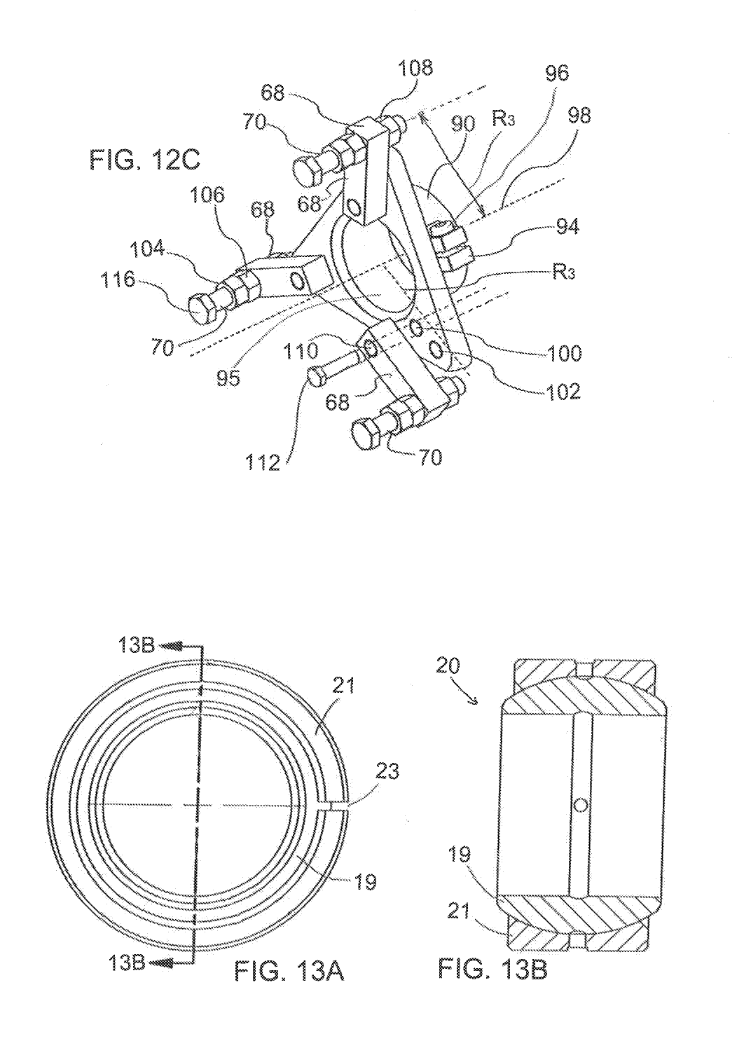

As generally shown in FIGS. 8 and 11A and 11B, in addition to the boring bar supports 12 discussed above, the universal offset portable boring bar support system 2 also comprises a spider support 66. The spider support 66 is a generally planar element which typically has three adjustable legs 68 and screws 70. The spider support 66 is typically utilized to provide additional support for an intermediate section of the boring bar 4 in the event that the pair of the boring bar support 12 are spaced excessively far away from one another (see FIG. 8, for example). Alternatively, the spider supports 66 may be utilized when additional support for the boring bar 4 is desired. A further detail description concerning set up and use of the spider support 66 will be provided below with respect to FIGS. 12A - 12D.

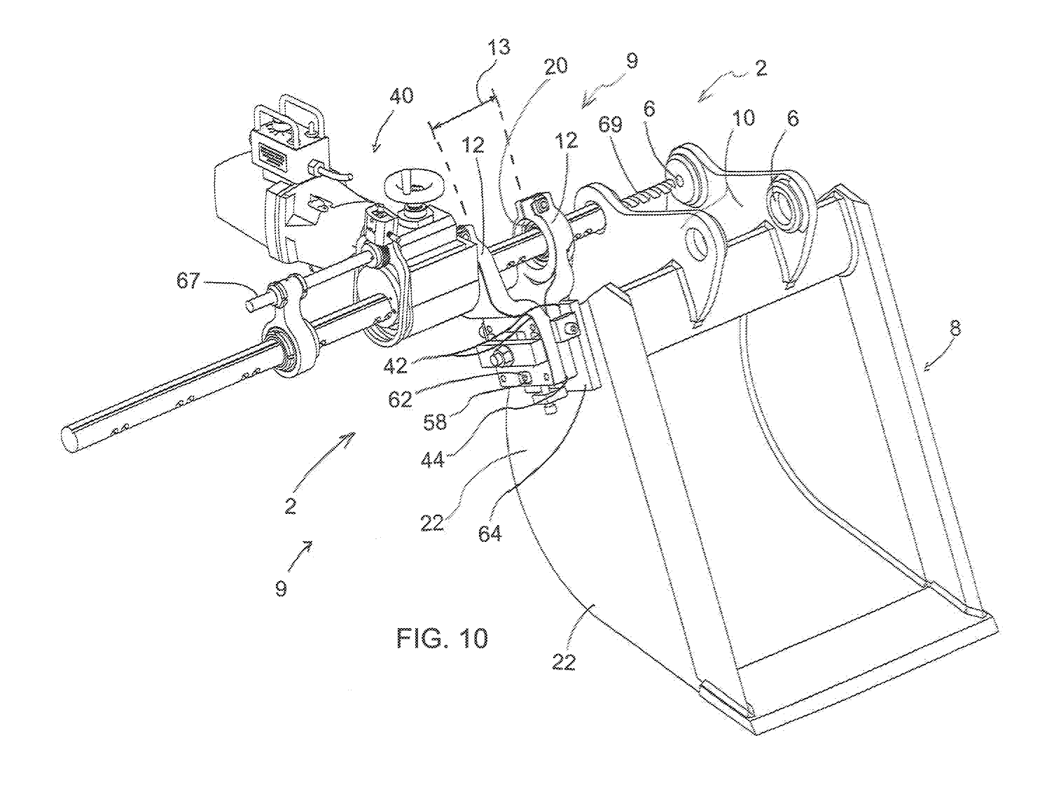

Depending on the desired process, the type(s) of tools to be utilized, the type and/or kind of bore 6 to be repaired, machined, cut, finished, etc., the boring bar support system 2 can be utilized in a variety of different arrangements and configurations. That is, the boring bar supports 12 can be configured in a standard support setup configuration, as shown in FIG. 8, in an inverted support setup configuration, as shown in FIG. 9, or in a dual support setup configuration, as shown in FIG. 10.

With reference now to FIG. 8, setup of a pair of boring bar supports 12, in the standard support setup configuration, will now be described. In order to facilitate such installation, a pair of cones are first utilized to center the boring bar 4 with respect to the bore 6 to be repaired, machined, cut, finished, etc. Next, a pair of sub-plates 64 are temporarily installed, e.g,, tack welded, securely clamped, etc., to two opposed surfaces 22 of the piece of equipment 8 at the determined suitable locations so that, when the boring bar supports 12 are subsequently mounted thereto, the central axes 28 of each of the clamping bores 30 will be generally aligned with the central axis the bore or bores 6 to be repaired, machined, cut, finished, etc.

As described above, each one of the mounting sub-plates 64 has a centrally located hold-down bolt 50 which is permanently attached to a central portion of the surface 63. Once each of the sub-plates 64 is temporarily attached to each respective surface 22, during mounting of the boring bar support 12, the hold-down bolt 50 passes through the bolt opening 48 of the respective boring bar support 12 and the hold-down 78 and then the associated nut 80 engages with leading end 51 of the hold-down bolt 50 to facilitate securing the boring bar support 12 to the respective mounting sub-plate 64. As described above, suitable tightening/loosening of the nut 80/the hold-down 78 allows desired vertical and lateral adjustment/movement of the boring bar support 12 relative to the hold-down bolt 50/the sub-plate 64 while suitable adjustment of one or more of the leveling screws 54 facilitates adjustment of the angular orientation of the central axis 28 of the clamping bore 30 with respect to the central axis 29 of the bore 6 to be repaired, machined, cut, finished, etc., so that all of the axes are substantially coincident with one another following completion of the adjustment process.

Once each of the respective clamping bores 30 is aligned with the bore 6 and the angular orientation of each of the respective central axes 28 is aligned with the central axis 29 of the bore 6, the respective nuts 80 and the hold-downs 78 are then sufficiently tightened to secure the boring bar support 12 in that adjusted positioned relative to the sub-plate 64 or the surface 22 of the piece of equipment 8. It should be noted here that when machining a surface, especially a bore 6, the precise alignment of the boring bar 4 can be critical. As such, it is extremely beneficial to be able to adjust both the lateral position as well as the angular orientation of the central axis 28 of the clamping bore 30 with respect to the central axis 29 of the bore 6A to be repaired, machined, cut, finished, etc., so that both axes are coincident with one another prior to initiating the repair process.

Turning now to FIGS. 6 and 9, the setup of the boring bar support 2 in an inverted boring bar setup configuration, with respect to a piece of equipment 8 to be repaired, machined, cut, finished, etc., will now be discussed. The inverted boring bar setup configuration 15 is characterized by a smaller distance or spacing 13 between the clamping collars 14 from one another in comparison to the distance or spacing 13 of the clamping collars 14 from one another in the standard boring bar setup configuration 11 discussed above. The primary difference between the standard boring bar setup configuration 11, described above, and the inverted boring bar setup configuration 15, is that the first surfaces 42, instead of the second surfaces 44, of the mounting plates 16 directly engage with the respective sub-plates 64 or surface 22 while the second surfaces 44, instead of the first surfaces 42, of the mounting plates 16 directly engage with the hold-down 78. Due to this arrangement, the leveling screws 54 must be removed from each of the respective leveling screw holes 52 and then reinserted into the leveling screw holes 52 from the opposite side of the mounting plate 16 to facilitate use thereof.

To facilitate secure support of a desired element or component, e.g., a gearbox 82 for example, within the clamping bore 30 of the clamping collar 14, a portion of the second surface 46 of the clamping collar 14 and/or a portion of the curvilinear section 18 may be partially removed, contoured or recessed—as diagrammatically shown by element 47 in FIG. 6 for example—so to provide additional space or room for accommodating such desired element or component without any obstruction hindering the desired clamping function by the clamping collar 14. Alternatively and/or in addition, the lateral displacement LD between the mounting plate 16 and the clamping collar 14 may be increased somewhat to provide additional space for accommodating such desired element or component. As the inverted boring bar setup configuration 15 is substantially identical to the standard support setup configuration 11 described above in virtually all other respects, a further detail description concerning the same is not provided.

Turning now to FIGS. 7A, 7B and 10, mounting of the dual support setup configuration 9 of the boring bar support system 2 to a piece of equipment 8 to be repaired, machined, cut, finished, etc., will now be described. According to the dual support setup configuration 9, first each one of the leveling screws 54 is removed from the respective leveling screw holes 52 of both of the boring bar supports 12 and an associated leveling set screw (not shown) is then threaded into only the leveling screw holes 52 of the boring bar support 12 which will directly engage with the sub-plate 64 or surface 22. Next, the first and second boring bar supports 12 are then directly secured to one another such that the machined second surfaces 44 of both of the mounting plates 16 directly abut against one another.

Once the second surfaces 44 of the mounting plates 16 are in direct engagement with one another, a respective joining bolt 58 is inserted into and through each of the joining bolt holes 62 in one of the mounting plates 16 until the leading threaded end of each respective joining bolt 58 extends out through the joining bolt hole 62 and into the pocket 56 of the other mounting plate 16. A mating nut 60 then threadedly engages with each of the respective leading threaded ends of the joining bolts 58. Next, each one of the joining bolts 58 and associated nuts 60 are then sufficiently tightened in order to secure the first and second boring bar supports 12 to one another and thereby form an integral dual support setup structure, as generally shown in FIGS. 7A and 7B.

As discussed above, the pockets 56 formed in the first surfaces 42 of the mounting plates 16 are sized to fully receive and accommodate either the head 57 of the joining bolt 58 or the mating nut 60, when the joining bolt 58 and nut 60 are threadedly engaged with one another, and thereby the joining bolts 58 avoid any contact or interference with either the hold-down 78 or the sub-plate 64 or surface 22. The joining bolts 58 should be of a sufficient length such that, when the joining bolts 58 are fully received and inserted into the pockets 56 of one mounting plate 16, the threaded leading end of each joining bolt 58 extends into the pocket 56 but does not protrude out of the pocket 56 beyond a plane defined by the first surface 42 of the other mounting plate 16. In this manner, the joining mechanisms, for coupling the first and the second boring bar supports 12 to one another, are each fully accommodated within the mounting platesl6, e.g., located between the first surfaces 42 of the two joined mounting plates 16.

Once the boring bar supports 12 are coupled to one another to form the integral dual support setup configuration 9 as generally shown in FIGS. 7A and 7B, the dual support setup configuration 9 is then secured to the surface of the sub-plate 64, or surface 22, in the manner described above, e.g., via use of the nut 80 and the hold-down 78 which engage with the hold-down bolt 50. It should be recognized that in this configuration 9, only the first surface 42 of one of the mounting plates 16 is secured directly to the surface of the sub-plate 64 while the first surface 42 of the other of the mounting plates 16 directly engages with the hold-down 78.

As discussed above, the dual support setup configuration 9 only employs leveling set screws which are threaded into the set screw holes 52 of one of the mounting plates 16, i.e., the mounting plate 16 which will directly engage with the support surface 63 of the sub-plate 64 or the surface 22. The leveling set screws 54 can be suitably manipulated by an appropriate tool, e.g., an alien wrench, which passes through the set screw hole 52 of the other mounting plate 16 and facilitates engagement with the head of the accommodated leveling set screws 52 to facilitate rotation thereof. Other than the differences described above, the manner in which the angular orientation of both the first and the second boring bar supports 12 are simultaneously adjusted or modified, with respect to the surface of the piece of equipment 8 and the bore 6 to be repaired, machined, cut, finished, etc., is generally the same as discussed above.

In the dual support setup configuration 9 as generally shown in FIG. 10, the first inner boring bar support 12 (the support located closest to the bore 6 to be repaired, machined, cut, finished, etc.) typically supports the bearing 20 while the second boring bar support 12 (the support located furthest away from the bore 6 to be repaired, machined, cut, finished, etc.) typically supports a boring bar drive 40 or some other accessory that is generally required to be axially aligned with both the clamping bore 30 and the bore 6 to be repaired, machined, cut, finished, etc. Alignment of the clamping bores 30, relative to one another, is critical for the a dual support setup configuration since the boring bar 4 has to pass through both clamping bores 30. In order to achieve proper alignment, the following is generally required: a) both of the clamping bores 30 need to be coaxially aligned with one another; b) the joining bolt holes 62 need to be consistently machined at the same relative location on the mounting plates 16; and c) the leveling screw holes 52 need to be consistently machined at the same relative location on the mounting plates 16 so that they are precisely aligned with one another when the first and the second boring bar supports 12 are fastened together in the dual support setup configuration 9 to thereby permit access and adjustment of the leveling set screws.

The dual support setup configuration 9 is characterized by a relatively small distance or spacing 13 (FIG. 10) between the first and the second boring bar supports 12 and/or is typically used when extra boring bar stiffness is required, such as when drilling a blind bore or when the bore 6 to be machined is located at a sufficiently large distance away from the first and the second boring bar supports 12. The dual support setup configuration 9 can also be used as a drill press with a pilot hole drill 69 with a conventional special Morse taper and an automatic feed rate control bar 67 (see FIG. 10) which facilitates mounting of the drive motor 40 and the boring bar bearing 20 to the clamping bore 30 of either one of the first and the second boring bar supports 12.

It is to be appreciated that the various mounting configurations of the present invention are not limited to the setup configurations discussed above. For example, it is possible to combine, if desired, the standard support setup configuration and the inverted support setup configuration with one another. In such instance, one of the boring bar supports 12 is secured to the piece of equipment 8 via the second surface 44 of the boring bar support 12 (e.g., in a standard support setup configuration), while the other boring bar support 12 is secured to the piece of equipment 8 via the first surface 42 of the boring bar support 12 (e.g., in an inverted support setup configuration).

As briefly discussed above, the universal offset portable boring bar support system 2 also comprises a spider support 66 which can be used to provide the boring bar 4 with additional support and rigidity if, for example, there is a sufficiently large distance or space 13 between the first and the second bore bar supports 12 (FIG. 8) or can be used in place of the second one of the bore bar supports 12 (FIGS. 11A and 11B). Alternatively, the spider support 66 may be used to help support the boring bar 4 or another tool or drive device, such as a drive gearbox 82.

Turning now to FIGS. 11A and 11B, these drawings illustrate a boring bar support system 2 that include a spider support 66 which is fixed to one of the brackets 10 of the bucket 8. In this example, the support system 2 supports a bore welder 84 with a plug-in center support 86 fixedly retained by a first one of the boring bar supports 12 and a quick connect welding gun 88 being aligned by the spider support 66 so as to facilitate welding a bore.

Further details of the spider support 66 are shown in FIGS. 12A 12D and discussed in detail. The spider support 66 generally comprises a planar support plate 92 which has a central opening which is coincident with a split clamping collar 90 that is formed integral with the support plate 92. The support plate 92 is generally planar and substantially triangular in shape. It should be appreciated that the support plate 92 can have a variety of different shapes and sizes without departing from the spirit and scope of the present invention. The clamping collar 90 of the spider support 66 is very similar to the clamping collar 14 of the boring bar support 12 and, therefore, only the differences between the clamping collar of the boring bar support 12 and the clamping collar 90 of the spider support 66 will be discussed in detail below.

The opposed ends of each section of the collar terminate in one of the lugs 94. The lugs 94 of the clamping collar 90 of the spider support 66 typically do not have any pockets for receiving the nut or the head of a clamping bolt 96, but each of the lugs 94 could, if necessary or desired, be provided with pockets. A peripheral edge portion of the clamping collar 90 is formed integrally with one of the front and rear surfaces of the support plate 92 such that a central bore axis 98 of the clamping collar 90 is arranged and extends perpendicular to the support plate 92. The clamping collar 90 comprises a cylindrically shaped inwardly facing clamping surface 95 for receiving and clamping the exterior surface of a desired component, element, bearing, etc., thereto. The lugs 94 are spaced from one another by a small distance or a gap, e.g., ⅛ to ¼ of an inch or so. Each one of the lugs 94 has a corresponding bolt hole (not shown) which extends completely through the respective lug 94 and both of the bolt holes are aligned with one another so as to facilitate to receiving a clamping bolt 96 and a mating nut. When the bolt 96 and the nut are sufficiently tightened or loosened, they permit the mating lugs 94 to move either toward or away from one another and the thereby facilitate either clamping or releasing of a desired bearing, drive gearbox, member, etc., by the cylindrical clamping surface 95.

The support plate 92 typically comprises three pairs of radially inner bores 100 and radially outer bores 102. The centers of each of the inner and outer radial bores 100, 102 are aligned with and extend parallel to the clamping bore centerline 98. The inner and outer bores 100, 102 are sized to receive a respective leveling screw 70 which, in turn, engages with a lock nut 104, a bevel nut 106 and a securing nuts 108. As generally shown in FIG. 12A for example, the leveling screw 70 and the associated bevel and securing nuts 106, 108 engage, on either side of the support plate 92, with a respective one of the inner bores 100 while, as generally shown in FIG. 12B, the leveling screw 70 and the associated bevel and securing nuts 106, 108 engage, on either side of the support plate 92, with a respective one of the outer bores 102.

In the event that the surface 63, 22 against which the heads 116 of the leveling screws 70 are to engage is spaced radially further away from the central axis 98 of the clamping collar 90, than either the inner or the outer bores 100, 102, then three leg extenders 68 (see FIGS. 12C and 12D) may engaged with each one of the three the inner or outer bores 100, 102. Each leg extender 68 has a first through bore 110 and a coupling bolt 112 extends through the first through bore 110 and a desired one of the inner and the outer bores 100, 102 of the support plate 92 and then threadedly engages with a respective nut to facilitate secure attachment of each of the three leg extenders 68 to the support plate 92 of the spider support 66.

The opposite end of the leg extender 68 has a second through bore 114 which receives one of the leveling screws 70. Each leveling screws 70, in turn, threadedly engages with a respective lock nut 104, bevel nut 106 and securing nut 108, as generally described above and shown in FIGS. 12C and 12D.

According to FIG. 12C, a respective coupling bolt 112 engages with the inner bore 100 of the support plate 92 and the first through bore 110 of the leg extender 68. At the opposite end of the leg extender 68, an associated leveling screw 70 engages with the second through bore 114 and then with associated lock, bevel and securing nuts 104, 106, 108. Alternatively, as generally shown in FIG. 120, a respective coupling bolt 112 engages with the outer bore 102 of the support plate 92 and the first through bore 110 of the leg extender 68. At the opposite end of the leg extender 68, an associated leveling screw 70 engages with the second through bore 114 and then with associated lock, bevel and securing nuts 104, 106, 108.

The above arrangement enables the leveling screws 70 to be arranged in a number of different orientations, e.g., at a number of different radially spaced locations, with respect to the central axis 98 of the clamping collar 90. The leveling screws 70, as shown in FIGS. 12A-12D, are illustrated as being arranged at four different radii R1, R2, R3, R4 from the central axis 98 of the clamping collar 90 with the smallest radius R1 shown in FIG. 12A and the largest radius R4 shown in FIG. 12D. The desired arrangement of the spider support 66 and the leveling screws 70 typically depends upon the available space for the mounting of the spider support 66, the overall design of the piece of equipment 8 and or the desired rigidity of the boring bar support system 1, etc.

The function of the leveling screws 70 of the spider support 66 is the same as that of the leveling screws 54 of the boring bar supports 12, i.e., both facilitate proper alignment of the respective clamping collars 90, 14, and thus the boring bar 4, in a desired angular orientation with respect to the bore 6 to be repaired, machined, etc. However, during use, the leveling screws 70 of the spider support differ from the leveling screws 54 of the boring bar supports 12 in that when mounting the spider support 66, the each leveling screw 70 is first inserted into the selected inner and/or outer bores 100, 102, in the desired arrangement, and then engaged with associated lock, bevel and securing nuts 104, 106, 108.

The spider support 66 is generally assembled, as shown in FIGS. 12A-12D, and then approximately aligned such that the central axis 98 of the spider support 66 is approximately coaxial with the central axis 28 of the boring bar support 12. Next, the head 116 of the leveling screws 70 are then tack welded to a desired surface 22 of the equipment 8. Finally, the lock, bevel and securing nuts 104, 106, 108 are then suitably adjusted so as to properly align and secure the support plate 92, and thus the spider support 66, in a desired angular orientation with respect to the surface 22 of the piece of equipment 8 and the bore 6 to be repaired, machined, cut, finished, etc., so that the central axis 98 of the spider support 66 is substantially coaxial with the central axis 28 of the boring bar support 12.

While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein are meant to encompass the items listed thereafter and equivalents thereof as well as additional items and be given the broadest possible meaning.

Wherefore, I/we claim:

1. A boring bar support comprising:
a split clamping collar supported adjacent a first end of the boring bar support, the split clamping collar defining a clamping bore having a central axis, the clamping bore facilitating releasable clamping attachment of a desired component thereto, and a lug and fastener assembly of the split clamping collar controlling a clamping motion of the split clamping collar;
a mounting plate supported adjacent a second opposite end of the boring bar support;
a curvilinear section coupling and integrally interconnecting the split clamping collar with the mounting plate in an offset manner with respect to one another; and
the mounting plate having an opening therein which facilitates attachment of the boring bar support to a desired surface.

2. The boring bar support according to claim 1, wherein the clamping collar comprises a cylindrically shaped inwardly facing clamping surface for receiving and clamping an exterior surface of a desired component, and opposed ends the clamping collar are spaced from one another, and when the opposed ends are biased toward one another by the fastener assembly, the clamping collar provides a clamping force to the desired component while, when the opposed ends move away from one another, the clamping collar facilitates release of the desired component.

3. The boring bar support according to claim 1, wherein the mounting plate has a bolt opening provided therein for receiving a hold-down bolt, and the bolt opening is sized to permit relative movement of the boring bar support with respect to the hold-down bolt.

4. The boring bar support according to claim 1, wherein the mounting plate has a plurality of leveling screw holes formed therein, and each leveling screw hole accommodates a leveling screw which facilitates adjustment of the boring bar support relative to the desired surface.

5. The boring bar support according to claim 1, wherein the mounting plate has a plurality of joining bolt holes which are sized for receiving a joining fastener which facilitates joining of the mounting plates of two boring bar supports to one another in a dual support setup configuration.

6. The boring bar support according to claim 1, wherein a surface of the mounting plate extends parallel to a surface of the split clamping collar, and the curvilinear section offsets the surface of the mounting plate from the surface of the split clamping collar by an offset of between 1 to 5 inches.

7. The boring bar support according to claim 1, wherein the boring bar support is used in combination with a spider support,
the spider support generally comprises a planar support plate which has an integral split spider clamping collar, and
the split spider clamping collar acilitates releasable attachment of a desired component thereto.

8. The boring bar support according to claim 1, wherein the spider support comprises three sets of radially inner and radially outer bores, and each set of the inner and the outer bores is sized for receiving a respective leveling screw; and
the spider support further comprises three leg extenders, each of the leg extenders has a first through bore for engages with a bolt to facilitate attachment to one of the inner and the outer bores of the support plate, and an opposite end of each leg extender has a threaded second through bore which receives one of the leveling screws.

9. A portable boring bar support system comprising first and second boring bar supports, and each of the first and the second boring bar supports comprising:
a split clamping collar supported adjacent a first end of the boring bar support, the split clamping collar defining a clamping bore having a central axis, the clamping bore facilitating releasable clamping attachment of a desired component thereto, and a lug and fastener assembly of the split clamping collar controlling a clamping motion of the split clamping collar;
a mounting plate supported adjacent a second opposite end of the respective boring bar support;
a curvilinear section coupling and integrally interconnecting the respective split clamping collar with the respective mounting plate in an offset manner with respect to one another; and
each mounting plate having an opening which facilitates attachment of the boring bar support to a desired surface.

10. The portable boring bar support system according to claim 9, wherein each of the clamping collars comprises a cylindrically shaped inwardly facing clamping surface for receiving and clamping an exterior surface of a desired component, and opposed ends the clamping collar are spaced from one another, and when the opposed ends are biased toward one another by the lug and fastener assembly, the clamping collar provides a clamping force to the desired component while when the opposed ends move away from one another, the clamping collar facilitates release of the desired component.

11. The portable boring bar support system according to claim 9, wherein each of the mounting plates has a bolt opening provided therein for receiving a hold-down bolt, and the bolt opening is sized to permit relative movement of the boring bar support with respect to the hold-down bolt.

12. The portable boring bar support system according to claim 11, wherein the hold-down bolt is accommodated within the bolt opening of the mounting plate to allow relative movement of the hold-down bolt with respect to the bolt opening, a leading threaded end of the hold-down bolt passes through a central aperture of the hold-down and engages with a nut, as the nut is tightened, the hold-down is moved along the hold-down bolt to facilitate clamping of the boring bar support to the desired surface while loosening of the nut permits adjustment of the boring bar support relative to the desired surface.

13. The portable boring bar support system according to claim 9, wherein each of the mounting plates has a plurality of leveling screw holes formed therein, each leveling screw hole accommodates a leveling screw which facilitate adjustment of the boring bar support relative to the desired surface.

14. The portable boring bar support system according to claim 9, wherein each of the mounting plates has a plurality of joining bolt holes which are sized for receiving a joining fastener which facilitates joining of the mounting plates of two boring bar supports to one another a dual support setup configuration.

15. The portable boring bar support system according to claim 14, wherein a first surface of each of the mounting plates has a plurality of recessed pockets formed therein, one of the plurality of joining bolt holes is formed in the base of each of the plurality of the pockets, and each pocket is sufficiently deep so as to completely receive and accommodate one of a nut and a head of a joining bolt.

16. The portable boring bar support system according to claim 11, wherein each of the mounting plates has a plurality of leveling screw holes formed therein, each leveling screw hole accommodates a leveling screw which facilitate adjustment of the boring bar support relative to the desired surface;
each of the mounting plates has a plurality ofjoining bolt holes which are sized for receiving a fastener which facilitates joining of the mounting plates of two boring bar supports to one another;
the leveling screw holes provided in the first boring bar support are a mirror image of the leveling screw holes provided in the second boring bar support so as to facilitate joining of the first boring bar support with the second boring bar support in a dual support setup configuration; and
the joining bolt holes provided in the first boring bar support are a mirror image of the joining bolt holes provided in the second boring bar support so as to facilitate joining of the first boring bar support with the second boring bar support in the dual support setup configuration.

17. The portable boring bar support system according to claim 11, wherein the portable boring bar support system further comprises a spider support, the spider support generally comprises a planar support plate which has an integral split spider clamping collar, the split spider clamping collar defines a clamping bore which has a central axis, the clamping bore of the split spider facilitating releasable clamping attachment of a desired component thereto, and a spider fastener assembly of the split spider clamping collar controlling a clamping motion of the split spider clamping collar.

18. The portable boring bar support system according to claim 17, wherein the spider support comprises three sets of radially inner and radially outer bores, and each of the inner and the outer bores is sized for receiving a respective leveling screw.

19. The portable boring bar support system according to claim 11, wherein the spider support further comprises three leg extenders, each leg extender has a first through bore for engaging with a bolt to facilitate attachment to one of the inner and the outer bores of the support plate, and an opposite end of the leg extender has a second through bore which receives one of the leveling screws.

20. A method of supporting a boring bar with a portable boring bar support system comprising first and second boring bar supports, and each of the first and the second boring bar supports comprising a split clamping collar supported adjacent a first end of the respective boring bar support, each split clamping collar defining a clamping bore having a central axis, each clamping bore facilitating releasable clamping attachment of a desired component thereto, and a lug and fastener assembly of the split clamping collar controlling a clamping motion of the split clamping collar; a mounting plate supported adjacent a second opposite end of the boring bar support; a curvilinear section coupling and integrally interconnecting the split clamping collar with the mounting plate in an offset manner with respect to one another; and the mounting plate having an opening which facilitates attachment of the boring bar support to a desired surface; the method comprising the steps of:
supporting the first and the second boring bar supports on a piece of equipment to be repaired; and
supporting the boring bar via the split clamping collar of at least one of the first and the second boring bar supports.
